(19) United States
(12) Patent Application Publication
(10) Pub. No.: US 2025/0046209 A1
(43) Pub. Date: Feb. 6, 2025

(54) SYSTEMS AND METHODS FOR INTERACTIVE TRAINING USING VIRTUAL REALITY

(71) Applicant: Home52 LLC, Blue Ash, OH (US)

(72) Inventor: Suzanne A. Burke, Wyoming, OH (US)

(21) Appl. No.: 18/794,429

(22) Filed: Aug. 5, 2024

Related U.S. Application Data
(60) Provisional application No. 63/530,829, filed on Aug. 4, 2023.

(51) Int. Cl. G09B 9/00; G06F 3/04815

(52) U.S. Cl. CPC G09B 9/00; G06F 3/04815

(57) ABSTRACT

Certain aspects provide systems and methods including receiving input of selection of one of a plurality caregiver training modules using a virtual reality device; displaying a first avatar in a virtual reality environment of the selected one caregiver training module; viewing, from a first perspective of the first avatar, a plurality of health challenges associated with the first avatar; interacting with the first avatar in the virtual reality environment via a plurality of prompts; selecting one of a plurality of responses, in response to the plurality of prompts; iteratively repeating the interaction with the first avatar up to a threshold number of the plurality of prompts; and completing the selected one caregiver training module.

### CLAIM TO PRIORITY

This non-provisional patent application claims priority to and benefit of, under 35 U.S.C. § 119(e), U.S. Provisional Patent Application Ser. No. 63/530,829, filed Aug. 4, 2023 and titled “Systems And Methods For Interactive Training Using Virtual Reality”, all of which is incorporated by reference herein.

### TECHNICAL FIELD

The present specification relates to systems and methods for interactive training using virtual reality.

### BACKGROUND

It is desirable to teach and train potential caregivers or even experienced caregivers how to react in a given caregiver scenario. However, such training is limited and not fully appreciative of a user experience if the potential or experienced caregiver merely reads a caregiver manual or watches a caregiver video without any interaction or collaboration. These and other deficiencies exist.

### BRIEF SUMMARY

In one embodiment, a method is disclosed. The method includes receiving input of selection of one of a plurality caregiver training modules using a virtual reality device. The method includes displaying a first avatar in a virtual reality environment of the selected one caregiver training module. The method includes viewing, from a first perspective of the first avatar, a plurality of health challenges associated with the first avatar. The method includes interacting with the first avatar in the virtual reality environment via a plurality of prompts. The method includes selecting one of a plurality of responses, in response to the plurality of prompts. The method includes iteratively repeating the interaction with the first avatar up to a threshold number of the plurality of prompts. The method includes completing the selected one caregiver training module.

In another embodiment, a system is disclosed. The system includes one or more processors; and one or more memories. The one or more processors are configured to receive input of selection of one of a plurality caregiver training modules using a virtual reality device. The one or more processors are configured to display a first avatar in a virtual reality environment of the selected one caregiver training module. The one or more processors are configured to view, from a first perspective of the first avatar, a plurality of health challenges associated with the first avatar. The one or more processors are configured to interact with the first avatar in the virtual reality environment via a plurality of prompts. The one or more processors are configured to select one of a plurality of responses, in response to the plurality of prompts. The one or more processors are configured to iteratively repeat the interaction with the first avatar up to a threshold number of the plurality of prompts. The one or more processors are configured to complete the selected one caregiver training module.

In another embodiment, a non-transitory computer-readable medium comprising instructions that, when executed by at least one processor, cause the at least one processor to perform operations is provided, the operations comprising: receiving input of selection of one of a plurality caregiver training modules using a virtual reality device; displaying a first avatar in a virtual reality environment of the selected one caregiver training module; viewing, from a first perspective of the first avatar, a plurality of health challenges associated with the first avatar; interacting with the first avatar in the virtual reality environment via a plurality of prompts; selecting one of a plurality of responses, in response to the plurality of prompts; iteratively repeating the interaction with the first avatar up to a threshold number of the plurality of prompts; and completing the selected one caregiver training module.

These and additional features provided by the embodiments described herein will be more fully understood in view of the following detailed description in conjunction with the drawings.

### DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 illustrates an example environment in which the systems and methods of the present disclosure may be used according to one or more embodiments shown and described herein.

FIG. 2 illustrates a method according to one or more embodiments shown and described herein.

FIG. 3 illustrates a menu selection of a plurality of training modules according to one or more embodiments shown and described herein.

FIG. 4A illustrates an example virtual reality user interface for a selected training module according to one or more embodiments shown and described herein. FIG. 4B illustrates an example virtual reality interface for the selected training module according to one or more embodiments shown and described herein. FIG. 4C illustrates an example virtual reality interface for the selected training module according to one or more embodiments shown and described herein. FIG. 4D illustrates an example virtual reality interface for the selected training module according to one or more embodiments shown and described herein. FIG. 4E illustrates an example virtual reality interface for the selected training module according to one or more embodiments shown and described herein. FIG. 4F illustrates an example virtual reality interface for the selected training module according to one or more embodiments shown and described herein. FIG. 4G illustrates an example virtual reality interface for the selected training module according to one or more embodiments shown and described herein.

FIG. 5A illustrates an example virtual reality user interface for a selected training module according to one or more embodiments shown and described herein. FIG. 5B illustrates an example virtual reality interface for the selected training module according to one or more embodiments shown and described herein. FIG. 5C illustrates an example virtual reality interface for the selected training module according to one or more embodiments shown and described herein. FIG. 5D illustrates an example virtual reality interface for the selected training module according to one or more embodiments shown and described herein.

FIG. 6A illustrates an example virtual reality user interface for a selected training module according to one or more embodiments shown and described herein. FIG. 6B illustrates an example virtual reality interface for the selected training module according to one or more embodiments shown and described herein. FIG. 6C illustrates an example virtual reality interface for the selected training module according to one or more embodiments shown and described herein. FIG. 6D illustrates an example virtual reality interface for the selected training module according to one or more embodiments shown and described herein.

FIG. 7A illustrates an example virtual reality user interface for a selected training module according to one or more embodiments shown and described herein. FIG. 7B illustrates an example virtual reality interface for the selected training module according to one or more embodiments shown and described herein. FIG. 7C illustrates an example virtual reality interface for the selected training module according to one or more embodiments shown and described herein.

FIG. 8A illustrates an example virtual reality user interface for a selected training module according to one or more embodiments shown and described herein. FIG. 8B illustrates an example virtual reality interface for the selected training module according to one or more embodiments shown and described herein. FIG. 8C illustrates an example virtual reality interface for the selected training module according to one or more embodiments shown and described herein. FIG. 8D illustrates an example virtual reality interface for the selected training module according to one or more embodiments shown and described herein.

### DETAILED DESCRIPTION

Embodiments disclosed herein relate to systems and methods for interactive training using virtual reality.

The systems and methods disclosed herein provide techniques to improve user experience and impact the perspective and approach to care by caregiver users using an application executed on a virtual reality device, where the caregiver users step into an elderly individual's perspective to not only learn but also experience first-hand what they are feeling via real-time interaction, training, and education. By employing role reversal in conversation (and perspective) in different types of caregiver training modules, the caregiver users feel through the interactive conversation, rather than merely being prompted on screen to complete a given caregiver training module. In addition, each of the caregiver training modules are particularly configured for the user of the virtual reality device to avoid experiencing virtual reality sickness and dizziness, and the virtual environments (such as the color, rooms, personal items, and the like) as well as the avatars generated for each of the different types of caregiver training modules are customized for each module to enhance relatability to the caregiver user of the virtual reality device.

In some examples, the virtual reality device may be controlled with a controller, such as a remote. For example, the controller may include a plurality of buttons and a joystick. In some examples, by pressing or manipulating one of the plurality of buttons of the controller, the user of the virtual reality device may view or return to a main menu that displays, on the display screen of the virtual reality device, the plurality of caregiver training modules for selection. By pressing another one of the plurality of buttons of the controller, the user of the virtual reality device may view a settings menu for the headset or exit a given caregiver training module. In some examples, by pressing the another one of the plurality of the buttons of the controller for a predetermined duration, the user of the virtual reality device may virtually re-orient, such as re-center, themselves in the application. Without limitation, the predetermined duration may comprise at least two seconds. Moreover, to interact with the settings and main menus and different objects or avatars within a given caregiver training module, the user of the virtual reality device may use the controller to navigate via a laser pointer. The laser pointer allows the user of the virtual reality device to click and select a specific object or menu and navigate the experience for a given caregiver training module.

In some examples, cameras on the virtual reality device may be configured to detect hands and fingers of the user, where this information may be configured as input to determine which action to perform regarding the interaction with and selection of the plurality of caregiver training modules.

In some examples, the user of the virtual reality device can interact with the plurality of caregiver training modules with their hands. In other examples, the user of the virtual reality device can interact with the plurality of caregiver training modules with the remote.

In some examples, the user of the virtual reality device can interact with the plurality of caregiver training modules while seated and may have limited range of motion while reaching. However, it is understood, that the body posture of the user being seated is not limited to only this posture, and that other body postures may be used

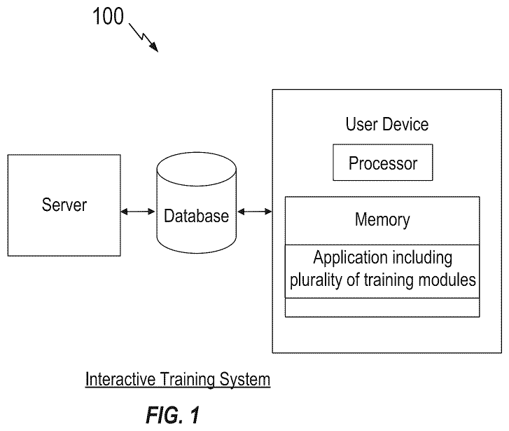

FIG. 1 illustrates an interactive training system 100. The interactive training system 100 includes a server, a database, and one or more user devices. The interactive training system 100 may be deployed in the illustrated exemplary environment deployed according to one or more embodiments. Although single instances of the constituent components of system 100 are depicted, any number of the constituent components of system 100 may be included.

The server may be connected to the database. In some examples, the server may be configured to exchange data with the database. The server may be configured as a central system, server or platform to control and call various data at different times to execute a plurality of operations as disclosed herein. Without limitation, the server may be configured to one or more requests for any operation from any constituent component of system 100 and transmit a response that is responsive to the one or more requests for any operation.

The one or more user devices may comprise any number of devices that are configured to connect to a network, such as the Internet, and download and install an application, such as application, into its one or more non-transitory computer-readable mediums, that includes the plurality of caregiver training modules. The one or more user devices may comprise at least one or more processors and at least one or more non-transitory computer-readable mediums (not shown) that stores the application. The one or more user devices (e.g., a personal computer, a tablet computer, a cellular telephone, a smartphone or other smart device, a stateless device, a virtual reality device or the like) may be used by a user to download and install the application into the one or more non-transitory computer-readable mediums of, for example a virtual reality device or another user device, such as a smartphone. The at least one or more processors of the one or more user device may be configured to execute logic, and the at least one or more non-transitory computer-readable mediums may be configured to store information and/or computer readable instructions.

The processor may be configured to receive input of selection of one of a plurality of caregiver training modules using a virtual reality device. In some examples, the input may comprise a manipulation of a controller that is connected with a virtual reality device headset, a voice command, a hand gesture, or any combination thereof. The input, such as the manipulation of a controller, the voice command, or the hand gesture or any combination thereof, may be provided by a user of the virtual reality device. Without limitation, the user may comprise a caregiver. However, it is understood that the user may include any type of user.

The plurality of caregiver training modules may be stored in the memory, and comprises a medication management conversation module, an incontinence conversation module, a hallucination conversation module, an end-of-life conversation module, and a caregiver burnout conversation module. As will be further discussed below, each of these modules may be particularly configured to train the user of the virtual reality device. The selection of one of the plurality of caregiver training modules using the virtual reality device may be provided by the user input. In some examples, each of the plurality of caregiver training modules may be displayed for selection on a display screen of the virtual reality device. Each of the plurality of caregiver training modules may be stored in memory, and are interactive in real-time with the user of the virtual reality device via the display screen of the virtual reality device. In some examples, each of the plurality of caregiver training modules may be of any duration, including but not limited up to ten minutes.

In some examples, other types of caregiver training modules may be used. Without limitation, these may include: managing fall prevention; spotting hazards in a home environment; skilled nursing task training; stroke conversations; home modifications conversations; assessing and preparing for condition changes; leveraging AI in gameplay; conversations about technology; conversations about discharging home and management of health changes; finance management; transfers; bathing and personal care management; and building onto the caregiver burnout scenarios, such as situational substance abuse, planning/spotting red flags in the conditions of a loved one, and managing fatigue.

In some examples, the plurality of caregiver training modules are not limited to a particular elder adult and a corresponding caregiver with an immediate child relationship. For example, younger caregivers, such as a grandchild, that interact with the plurality of caregiver training modules for a grandparent, or another loved one.

In some examples, the plurality of caregiver training modules may be configured for execution via an application stored in memory. The memory may belong to the virtual reality device. In other examples, the memory may belong to a different device, such as configured for execution via an application stored in memory of a mobile device. To the extent that an Internet or Wi-Fi connection is unavailable to execute the application including the plurality of caregiver training modules for interaction with the user of the of the virtual reality device, the mobile device may be configured, and in some examples forced, to locally store application data and push new information, such as updates to the application, when there is a reestablished Internet or Wi-Fi connection.

The medication management conversation module includes real-time interaction, training, and education with a user of the virtual reality device who is tasked with communicating with an older adult, for example, who is hesitant about taking their medications. Through this module, the user of the virtual reality device learns not only of the health challenges of the older adult, but also experiences first-hand what it is like for the older adult to have a vision impairment that is adversely impacted by one of their medications. In some examples, the user of the virtual reality device experiences first-hand, from the perspective of the older adult, the health challenges such as blurred vision (for example, due to a symptom of macular degeneration), and delayed reaction in attempting to pick up a ringing phone.

The incontinence conversation module includes real-time interaction, training, and education with the user of the virtual reality device who is introduced to an older adult, for example, who is experiencing incontinence and who can overhear their caregiver communicating about the older adult's issues to a physician without realizing that the older adult can hear them. Through this module, the user of the virtual reality device learns not only of the health challenges of the older adult, but also experiences first-hand what it is like for the older adult to overhear the conversation between the caregiver and the physician surrounding the incontinence issues. In some examples, the user of the virtual reality device can also navigate within a virtual environment or virtual room where the caregiver and/or the older adult are situated. For example, the virtual environment or background (including but not limited to colors, rooms, personal items, and the like) may be custom created to make the environment, for each of the plurality of caregiver training modules, more relatable to the user of the virtual reality device. The virtual environments may be simple, not visually over-stimulating.

The hallucination conversation module includes real-time interaction, training, and education with the user of the virtual reality device who is helping talking down a hallucination by an older adult, for example assisting with the breakdown in dialogue from the older adult experiencing the hallucination. Through this module, the user of the virtual reality device learns not only of the health challenges of the older adult, but also experiences first-hand what it is like to be immersed into the shoes of the older adult, for example, who has dementia and corresponding symptoms. The older adult experiences a hallucination and tries to call their caregiver for assistance, and the user of the virtual reality device is witnessing these events unfold in real-time. In some examples, the user of the virtual reality device can also directly experience the perspective of the older adult who is experiencing the hallucination, and is also tasked with talking down the hallucination of the older adult.

The end-of-life conversation module includes real-time interaction, training, and education with the user of the virtual reality device who is in a virtual hospital room and directly witnessing an end-of-live scenario between any number of individuals. Through this module, the user of the virtual reality device learns not only of the health challenges of the older adult, but also experiences first-hand what it is like for a stressful end-of-live scenario that takes place. In some examples, the user of the virtual reality device is virtually transported or taken back to a previous point in time in a moment of time where, for example, a son and their father have a discussion on the father's end-of-life wishes in a different virtual environment, such as a virtual home or the like. Upon completion of the discussion, the user of the virtual reality device is again taken back or virtually transported to the virtual hospital room to witness first-hand the positive impact the discussion had between the father and the son.

The caregiver burnout conversation module includes real-time interaction, training, and education with the user of the virtual reality device who is introduced to a virtual living space where they directly hear stories from any number of caregivers by selecting an object in the virtual living room with or without guidance from an avatar. By way of example, one of the caregivers introduces themselves to the user of the virtual reality device and comprises a female caregiver for their mother who is diagnosed with ALS. Each caregiver shares their experience, their feelings of burnout, and what they did to help the situation. Through this module, the user of the virtual reality device learns not only of the health challenges of the older adult, but also experiences first-hand what it is like for caregiver burnout from various caregiver perspectives. In some examples, the user of the virtual reality device can also navigate to and select or virtually approach each of the caregivers, via selecting a corresponding caregiver avatar, using the virtual reality device to learn from each caregiver. In addition, the user of the virtual reality device is, at the completion of each story, coached from an avatar, such as a narrator, on key points for each story.

In some examples, the virtual reality device comprises a virtual reality headset. Without limitation, the virtual reality headset may comprise a Meta® Quest® and Pro® headset. It is understood that other types of virtual reality devices may be used, such as virtual reality eyewear.

In some examples, the method includes authenticating a user via a facial recognition of the user or a voice recognition of the user, or any combination thereof. This authentication may be performed prior to receiving the input selection of one of the plurality of caregiver training modules using the virtual reality device.

The processor may be configured to generate and display a first avatar in a virtual reality environment of the selected caregiver training module. In some examples, the first avatar may comprise a user that is different than the caregiver, who requires care. The first avatar in the virtual reality environment of the selected caregiver training module may be displayed on the display screen of the virtual reality device.

In some examples, the first avatar is customizable based on a plurality of first user parameters including a gender, a race, an ethnicity, an age, a language, a dialect, an accent, or any combination thereof. For example, the first avatar may be customizable based on first user parameters comprising a female who is 40 years old. In some examples, the first user parameters may be displayed for selection on the display screen of the virtual reality device. In other examples, the first user parameters may be input by the user of the virtual reality device. In other examples, one or more of the first user parameters is customizable by one or more users, one or more healthcare providers, one or more third parties, or combinations thereof at various different times. For example, a virtual reality company may customize one or more parameters before it ships a headset to a healthcare provider, then the healthcare provider may customize one or more parameters, then a user may customize one or more parameters. It is understood that the plurality of first user parameters are not limited, and that any other type of first parameters may be used to generate the first avatar for selection on the display screen of the virtual reality device, including but not limited to, skin tone, hair color, height, build, clothes, culture, national origin, religion, disability, sexual orientation, socioeconomic status, education, marital status, veteran status, physical appearance, and the like.

Non-limiting examples of gender are male and female. Non-limiting examples of race are White, Black or African American, American Indian or Alaska Native, Asian, and Native Hawaiian or Other Pacific Islander. Non-limiting examples of ethnicity are Hispanic, Latino, and Spanish Origin. Non-limiting examples of a language are English, French, Japanese, Spanish, Portuguese, Hindi, Russian, German, Bengali, Arabic, and Mandarin Chinese. A dialect is a variety of a language. A dialect comprises particular vocabulary, pronunciation, grammar, syntax, or combinations thereof. It can be associated with a particular group of people or a particular geographical location. An accent is part of a dialect. An accent is a way of pronouncing words by people in a particular geographical location (e.g., city, state, region, country). It can be associated with socioeconomic background and status. Non-limiting examples of a dialect are Standard English and British English. Non-limiting examples of an accent are Southern, New England, New York City, and Midwestern.

In this manner, the first avatar may be generated by the processor based on desired selected first user parameters. Consequently, the user of the virtual reality device is provided an enhanced user experience, and is therefore more likely to learn and improve training during the selected caregiver training module, due to the degree of relatedness between the desired selected first user parameters and cognitive abilities of the user that build on the desired selected first user parameters (as opposed to selecting first parameters that do not beneficially improve learning or training of the user, or blindly selecting first parameters that do not beneficially improve learning or training of the user).

One or more of the user parameters chosen to customize an avatar may be collected and shared with a department of health. This user data can be used for various purposes. For instance, racial and ethnic backgrounds may place people at different risks for certain diseases. By knowing more about a user's racial and ethnic background, a medical provider may be better able to meet a user's health needs. By way of example, the user may be a novice or learning to become a caregiver, and they have primarily dealt with or previously cared for elderly males throughout their life thus far and therefore would be or likely to be more comfortable, and therefore more likely and adapted to learn and be trained, for which the first avatar is based on selected first user parameters comprising a male gender who is in an age range of 60 years to 70 years old. In this manner, the user is provided an enhanced user experience for the selected caregiver training module using the virtual reality device in which they deliberately select first user parameters that improve their individual ability to learn and be trained.

The processor may be configured to generate a view, from a first perspective of the first avatar, a plurality of health challenges associated with the first avatar. In some examples, the plurality of health challenges associated with the first avatar comprise a plurality of physical conditions associated with the first avatar, a plurality of mental conditions associated with the first avatar, or any combination thereof. Without limitation, the plurality of physical conditions associated with the first avatar may include blurry vision for any number and type of objects (such as a phone, a television, a chair, or the like), coughing, slow movements, physical disabilities, and the like. Without limitation, the plurality of mental conditions associated with the first avatar may include forgetfulness, emotional instability, fearfulness, uncertainty, and the like. In this manner, the user is able to experience first-hand the plurality of health challenges associated with the first avatar. By directly experiencing the plurality of health challenges associated with the first avatar through the visual display on the display screen of the virtual reality device, the user can improve their learning and training for the selected caregiver training module. In addition, because the user has substituted their frame of reference from their own to that of the first avatar, the user experience is augmented since they are now switched to directly witnessing and experiencing the symptoms of the plurality of health challenges of the first avatar, as opposed to relying on indirect experiences or second-hand accounts of the symptoms of the plurality of health challenges of the first avatar (or even relying on their own perspective).

Alternatively or additionally, the user can switch to a perspective different than that from the first avatar. For example, the user can switch to viewing, from a second perspective of their own or a second avatar, a plurality of health challenges associated with the first avatar. As with the first avatar, the second avatar is customizable based on a plurality of second user parameters, which may be the same or different parameters as the first plurality of first user parameters.

For example, the first avatar may be customizable based on second user parameters comprising a male who is 80 years old. In some examples, the second user parameters may be displayed for selection on the display screen of the virtual reality device. In other examples, the second user parameters may be input by the user of the virtual reality device. It is understood that the plurality of second user parameters are not limited, and that any other type of second parameters may be used to generate the second avatar for selection on the display screen of the virtual reality device, including but not limited to, skin tone, hair color, height, clothes, and the like. In some examples, the second user parameters available for selection or input by the first user via the virtual reality device may be the same as the first user parameters. In other examples, the second user parameters available for selection or input by the first user via the virtual reality device may be different than the first user parameters.

The processor may be configured to interact with the first avatar in the virtual reality environment via a plurality of prompts. In some examples, the plurality of prompts may comprise one or more queries from the first avatar that are displayed on the display screen of the virtual reality device. For example, one query from the first avatar comprises “Do I need to take those right now?”, with “those” referring to particular medication.

The processor may be configured to select one of a plurality of responses, in response to the plurality of prompts, in the selected caregiver training module. In some examples, the plurality of responses comprise one or more responses in response to the one or more queries from the first avatar. Continuing with the above example, one response from the user may be displayed for selection on the display screen of the virtual reality device. The one response comprises “Of course you do, why do we have to have this conversation everyday?” Alternatively, the one response for selection on the display screen of the virtual reality device comprises “Yes, you need to take them right now.” In some examples, either of these responses may be displayed adjacent to each other and each available for selection on the display screen of the virtual reality device, and in response to the one query from the first avatar.

The processor may be configured to iteratively repeated the interaction, in the selected caregiver training module, with the first avatar up to a threshold number of the plurality of prompts. In some examples, the interaction between the first avatar and the user may continue in the selected caregiver training module. In other words, the selected caregiver training module does not end merely at only one query and one response to the query. Rather, a second query may continue, and continuing with the above example, the second query comprises “Okay, but I don't know if I want to take the yellow one, it makes me feel funny.” A second response comprises “How could they possibly make you feel funny?” Alternatively, the second response comprises “What do you mean it makes you feel funny?” In some examples, either of these responses may be displayed adjacent to each other and each available for selection on the display screen of the virtual reality device, and in response to the second query from the first avatar. In this manner, the interaction between the first avatar and the user continues.

Further, each caregiver training module may include a threshold number of the plurality of prompts by the first avatar to the user before the caregiver training module ends. In some examples, the threshold number of the plurality of prompts for any given caregiver training module may be different or similar than that of other caregiver training modules.

The processor may be configured to complete the selected caregiver training module. For example, after reaching the threshold number of the plurality of prompts for the selected caregiver training module, the selected caregiver training module may terminate and return to a selection of the plurality of caregiver training modules on the main menu of display screen of the virtual reality device.

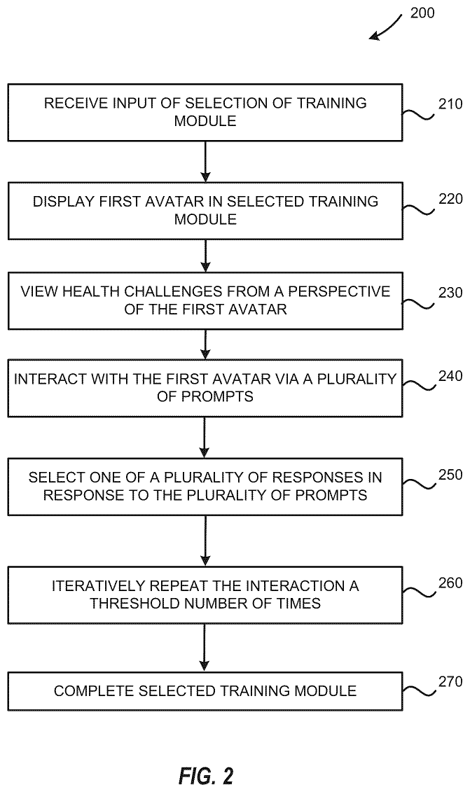

FIG. 2 illustrates a method 200. The method 200 may comprise a computer-implemented method for an application, such as application executing on a device, such as the user device 130. The method 200 may reference any of constituent components and functions described above with respect to FIG. 1. The method may comprise an interactive training method.

At block 210, the method may include receiving input of selection of one of a plurality of caregiver training modules using a virtual reality device. In some examples, the input may comprise a manipulation of a controller, a voice command, a hand gesture, or any combination thereof. The input, such as the manipulation of a controller, the voice command, or the hand gesture or any combination thereof, may be provided by a user of the virtual reality device. Without limitation, the user may comprise a caregiver. However, it is understood that the user may include any type of user.

The plurality of caregiver training modules comprises a medication management conversation module, an incontinence conversation module, a hallucination conversation module, an end-of-life conversation module, and a caregiver burnout conversation module. As will be further discussed below, each of these modules may be particularly configured to train the user of the virtual reality device. The selection of one of the plurality of caregiver training modules using the virtual reality device may be provided by the user input. In some examples, each of the plurality of caregiver training modules may be displayed for selection on a display screen of the virtual reality device. Each of the plurality of caregiver training modules may be stored in memory, and are interactive in real-time with the user of the virtual reality device via the display screen of the virtual reality device. In some examples, each of the plurality of caregiver training modules may be of any duration, including but not limited up to ten minutes.

In some examples, other types of caregiver training modules may be used. Without limitation, these may include: managing fall prevention; spotting hazards in a home environment; skilled nursing task training; stroke conversations; home modifications conversations; assessing and preparing for condition changes; leveraging AI in gameplay; conversations about technology; conversations about discharging home and management of health changes; finance management; transfers; bathing and personal care management; and building onto the caregiver burnout scenarios, such as situational substance abuse, planning/spotting red flags in the conditions of a loved one, and managing fatigue.

In some examples, the plurality of caregiver training modules are not limited to a particular elder adult and a corresponding caregiver with a child relationship. For example, younger caregivers, such as a grandchild, that interact with the plurality of caregiver training modules for a grandparent.

In some examples, the plurality of caregiver training modules may be configured for execution via an application stored in memory. The memory may belong to the virtual reality device. In other examples, the memory may belong to a different device, such as configured for execution via an application stored in memory of a mobile device. To the extent that an Internet or Wi-Fi connection is unavailable to execute the application including the plurality of caregiver training modules for interaction with the user of the of the virtual reality device, the mobile device may be configured, and in some examples forced, to locally store application data and push new information, such as updates to the application, when there is a reestablished Internet or Wi-Fi connection.

The medication management conversation module includes real-time interaction, training, and education with a user of the virtual reality device who is tasked with communicating with an older adult, for example, who is hesitant about taking their medications. Through this module, the user of the virtual reality device learns not only of the health challenges of the older adult, but also experiences first-hand what it is like for the older adult to have a vision impairment that is adversely impacted by one of their medications. In some examples, the user of the virtual reality device experiences first-hand, from the perspective of the older adult, the health challenges such as blurred vision, and delayed reaction in attempting to pick up a ringing phone.

The incontinence conversation module includes real-time interaction, training, and education with the user of the virtual reality device who is introduced to an older adult, for example, who is experiencing incontinence and who can overhear their caregiver communicating about the older adult's issues to a physician without realizing that the older adult can hear them. Through this module, the user of the virtual reality device learns not only of the health challenges of the older adult, but also experiences first-hand what it is like for the older adult to overhear the conversation between the caregiver and the physician surrounding the incontinence issues. In some examples, the user of the virtual reality device can also navigate within a virtual environment or virtual room where the caregiver and/or the older adult are situated. For example, the virtual environment or background (including but not limited to colors, rooms, personal items, and the like) may be custom created to make the environment, for each of the plurality of caregiver training modules, more relatable to the user of the virtual reality device. The virtual environments may be simple, not visually over-stimulating.

The hallucination conversation module includes real-time interaction, training, and education with the user of the virtual reality device who is helping talking down a hallucination by an older adult. Through this module, the user of the virtual reality device learns not only of the health challenges of the older adult, but also experiences first-hand what it is like to be immersed into the shoes of the older adult, for example, who has dementia and corresponding symptoms. The older adult experiences a hallucination and tries to call their caregiver for assistance, and the user of the virtual reality device is witnessing these events unfold in real-time. In some examples, the user of the virtual reality device can also directly experience the perspective of the older adult who is experiencing the hallucination, and is also tasked with talking down the hallucination of the older adult.

The end-of-life conversation module includes real-time interaction, training, and education with the user of the virtual reality device who is in a virtual hospital room and directly witnessing an end-of-live scenario between any number of individuals. Through this module, the user of the virtual reality device learns not only of the health challenges of the older adult, but also experiences first-hand what it is like for a stressful end-of-live scenario that takes place. In some examples, the user of the virtual reality device is virtually transported or taken back to a previous point in time in a moment of time where, for example, a son and their father have a discussion on the father's end-of-life wishes in a different virtual environment, such as a virtual home or the like. Upon completion of the discussion, the user of the virtual reality device is again taken back or virtually transported to the virtual hospital room to witness first-hand the positive impact the discussion had between the father and the son.

The caregiver burnout conversation module includes real-time interaction, training, and education with the user of the virtual reality device who is introduced to a virtual living space where they directly hear stories from any number of caregivers. By way of example, one of the caregivers introduces themselves to the user of the virtual reality device, and comprises a female caregiver for their mother who is diagnosed with ALS. Each caregiver shares their experience, their feelings of burnout, and what they did to help the situation. Through this module, the user of the virtual reality device learns not only of the health challenges of the older adult, but also experiences first-hand what it is like for caregiver burnout from various caregiver perspectives. In some examples, the user of the virtual reality device can also navigate to and select or virtually approach each of the caregivers, via selecting a corresponding caregiver avatar, using the virtual reality device to learn from each caregiver.

In some examples, the virtual reality device comprises a virtual reality headset. Without limitation, the virtual reality headset may comprise a Meta® Quest® and Pro® headset. It is understood that other types of virtual reality devices may be used, such as virtual reality eyewear.

In some examples, the method include authenticating a user via a facial recognition of the user or a voice recognition of the user, or any combination thereof. This authentication may be performed prior to receiving the input selection of one of the plurality of caregiver training modules using the virtual reality device.

At block 220, the method may include displaying a first avatar in a virtual reality environment of the selected caregiver training module. In some examples, the first avatar may comprise a user that is different than the caregiver, who requires care. The first avatar in the virtual reality environment of the selected caregiver training module may be displayed on the display screen of the virtual reality device.

In some examples, the first avatar is customizable based on a plurality of first user parameters including a gender, a race, an ethnicity, an age, a language, a dialect, an accent, or any combination thereof. For example, the first avatar may be customizable based on first user parameters comprising a female who is 40 years old. In some examples, the first user parameters may be displayed for selection on the display screen of the virtual reality device. In other examples, the first user parameters may be input by the user of the virtual reality device. In other examples, one or more of the first user parameters is customizable by one or more users, one or more healthcare providers, one or more third parties, or combinations thereof at various different times. For example, a virtual reality company may customize one or more parameters before it ships a headset to a healthcare provider, then the healthcare provider may customize one or more parameters, then a user may customize one or more parameters. It is understood that the plurality of first user parameters are not limited, and that any other type of first parameters may be used to generate the first avatar for selection on the display screen of the virtual reality device, including but not limited to, skin tone, hair color, height, build, clothes, culture, national origin, religion, disability, sexual orientation, socioeconomic status, education, marital status, veteran status, physical appearance, and the like.

In this manner, the first avatar may be generated based on desired selected first user parameters. Consequently, the user of the virtual reality device is provided an enhanced user experience, and is therefore more likely to learn and improve training during the selected caregiver training module, due to the degree of relatedness between the desired selected first user parameters and cognitive abilities of the user that build on the desired selected first user parameters (as opposed to selecting first parameters that do not beneficially improve learning or training of the user, or blindly selecting first parameters that do not beneficially improve learning or training of the user).

By way of example, the user may be a novice or learning to become a caregiver, and they have primarily dealt with or previously cared for elderly males throughout their life thus far and therefore would be or likely to be more comfortable, and therefore more likely and adapted to learn and be trained, for which the first avatar is based on selected first user parameters comprising a male gender who is in an age range of 60 years to 70 years old. In this manner, the user is provided an enhanced user experience for the selected caregiver training module using the virtual reality device in which they deliberately select first user parameters that improve their individual ability to learn and be trained.

At block 230, the method may include viewing, from a first perspective of the first avatar, a plurality of health challenges associated with the first avatar. In some examples, the plurality of health challenges associated with the first avatar comprise a plurality of physical conditions associated with the first avatar, a plurality of mental conditions associated with the first avatar, or any combination thereof. Without limitation, the plurality of physical conditions associated with the first avatar may include blurry vision for any number and type of objects (such as a phone, a television, a chair, or the like), coughing, slow movements, physical disabilities, and the like. Without limitation, the plurality of mental conditions associated with the first avatar may include forgetfulness, emotional instability, fearfulness, uncertainty, and the like. In this manner, the user is able to experience first-hand the plurality of health challenges associated with the first avatar. By directly experiencing the plurality of health challenges associated with the first avatar through the visual display on the display screen of the virtual reality device, the user can improve their learning and training for the selected caregiver training module. In addition, because the user has substituted their frame of reference from their own to that of the first avatar, the user experience is augmented since they are now switched to directly witnessing and experiencing the symptoms of the plurality of health challenges of the first avatar, as opposed to relying on indirect experiences or second-hand accounts of the symptoms of the plurality of health challenges of the first avatar (or even relying on their own perspective).

Alternatively or additionally, the user can switch to a perspective different than that from the first avatar. For example, the user can switch to viewing, from a second perspective of their own or a second avatar, a plurality of health challenges associated with the first avatar. As with the first avatar, the second avatar is customizable based on a plurality of second user parameters, which may be the same or different parameters as the first plurality of first user parameters.

For example, the first avatar may be customizable based on second user parameters comprising a male who is 80 years old. In some examples, the second user parameters may be displayed for selection on the display screen of the virtual reality device. In other examples, the second user parameters may be input by the user of the virtual reality device. It is understood that the plurality of second user parameters are not limited, and that any other type of second parameters may be used to generate the second avatar for selection on the display screen of the virtual reality device, including but not limited to, skin tone, hair color, height, clothes, and the like. In some examples, the second user parameters available for selection or input by the first user via the virtual reality device may be the same as the first user parameters. In other examples, the second user parameters available for selection or input by the first user via the virtual reality device may be different than the first user parameters.

At block 240, the method may include interacting with the first avatar in the virtual reality environment via a plurality of prompts. In some examples, the plurality of prompts may comprise one or more queries from the first avatar that are displayed on the display screen of the virtual reality device. For example, one query from the first avatar comprises “Do I need to take those right now?”, with “those” referring to particular medication.

At block 250, the method may include selecting one of a plurality of responses, in response to the plurality of prompts, in the selected caregiver training module. In some examples, the plurality of responses comprise one or more responses in response to the one or more queries from the first avatar. Continuing with the above example, one response from the user may be displayed for selection on the display screen of the virtual reality device. The one response comprises “Of course you do, why do we have to have this conversation everyday?” Alternatively, the one response for selection on the display screen of the virtual reality device comprises “Yes, you need to take them right now.” In some examples, either of these responses may be displayed adjacent to each other and each available for selection on the display screen of the virtual reality device, and in response to the one query from the first avatar.

At block 260, the method may include iteratively repeating the interaction, in the selected caregiver training module, with the first avatar up to a threshold number of the plurality of prompts. In some examples, the interaction between the first avatar and the user may continue in the selected caregiver training module. In other words, the selected caregiver training module does not end merely at only one query and one response to the query. Rather, a second query may continue, and continuing with the above example, the second query comprises “Okay, but I don't know if I want to take the yellow one, it makes me feel funny.” A second response comprises “How could they possibly make you feel funny?” Alternatively, the second response comprises “What do you mean it makes you feel funny?” In some examples, either of these responses may be displayed adjacent to each other and each available for selection on the display screen of the virtual reality device, and in response to the second query from the first avatar. In this manner, the interaction between the first avatar and the user continues.

Further, each caregiver training module may include a threshold number of the plurality of prompts by the first avatar to the user before the caregiver training module ends. In some examples, the threshold number of the plurality of prompts for any given caregiver training module may be different or similar than that of other caregiver training modules.

At block 270, the method may include completing the selected caregiver training module. For example, after reaching the threshold number of the plurality of prompts for the selected caregiver training module, the selected caregiver training module may terminate and return to a selection of the plurality of caregiver training modules on the display screen of the virtual reality device.

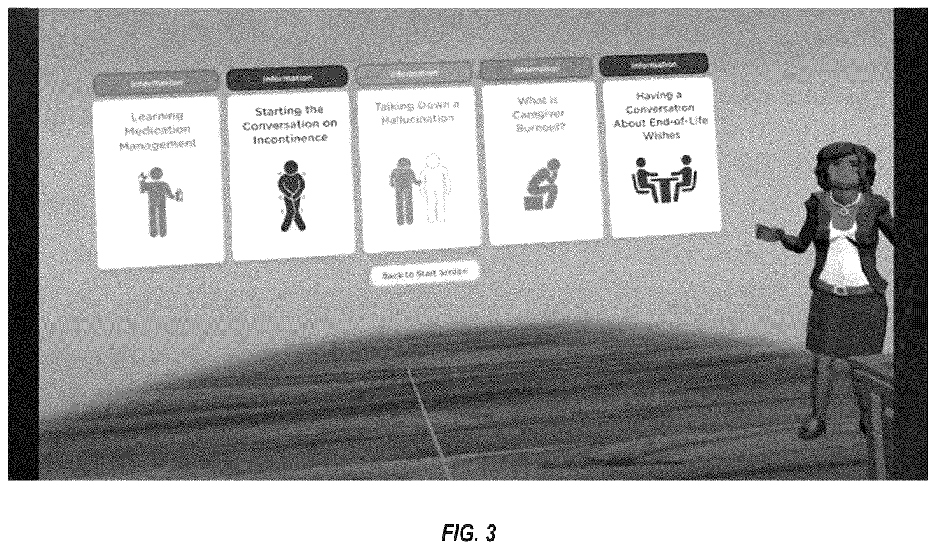

FIG. 3 illustrates a menu selection of a plurality of training modules according to one or more embodiments shown and described herein. The plurality of training modules may refer to the plurality of training modules as previously explained above, and displayed on the display screen of the virtual reality device. The following figures depict example virtual reality user interfaces for a particular caregiver training module that are displayed on the display screen of the virtual reality device for selection, viewing, and interaction by the user.

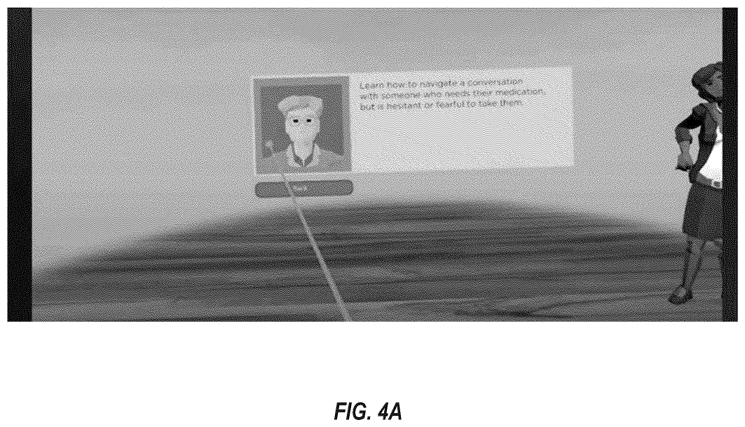

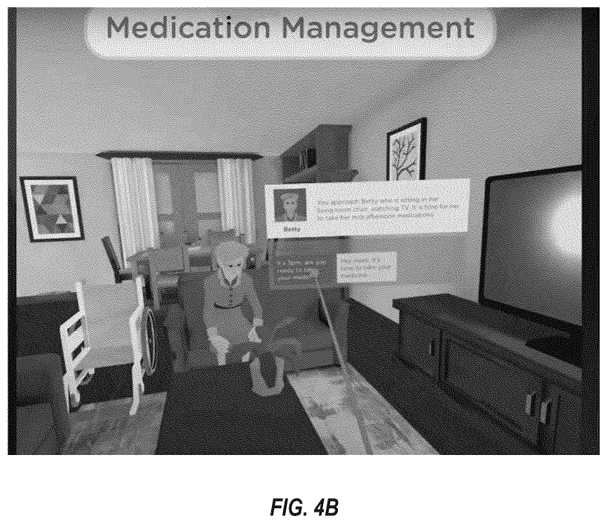

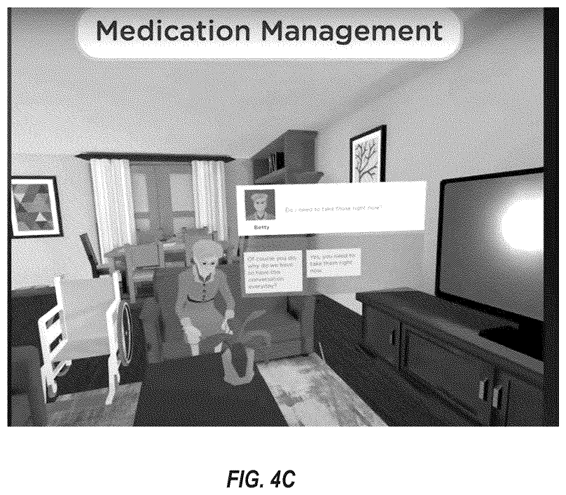

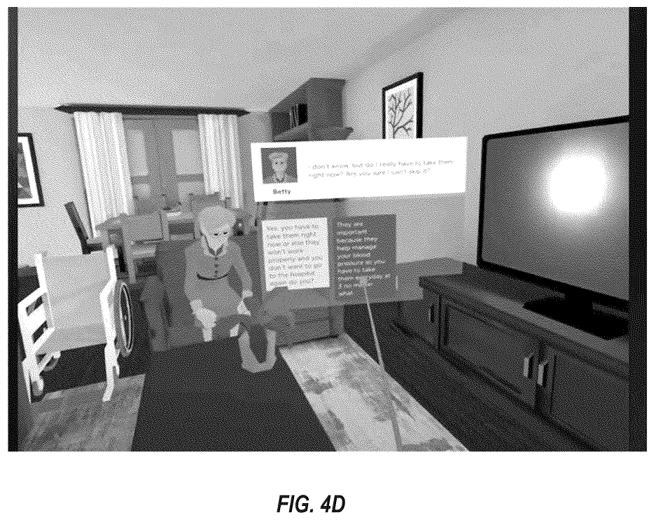

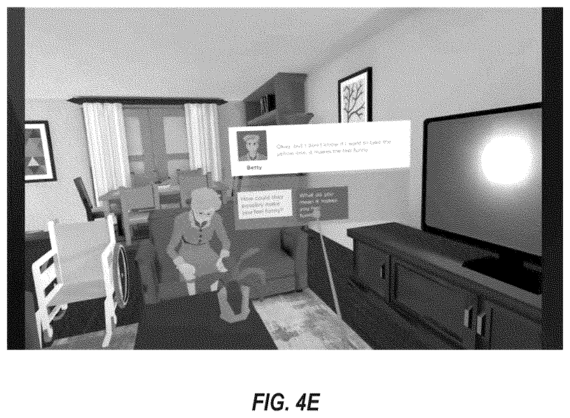

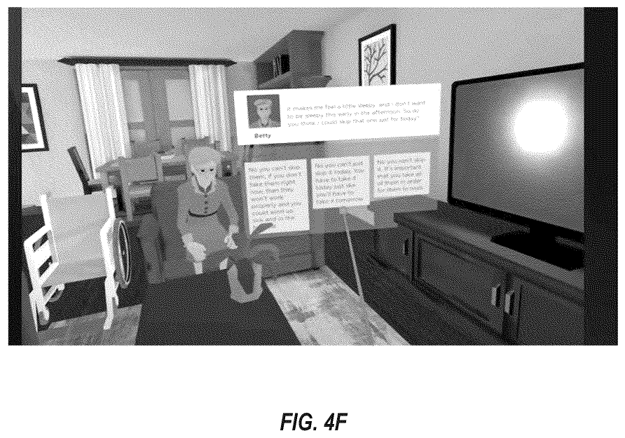

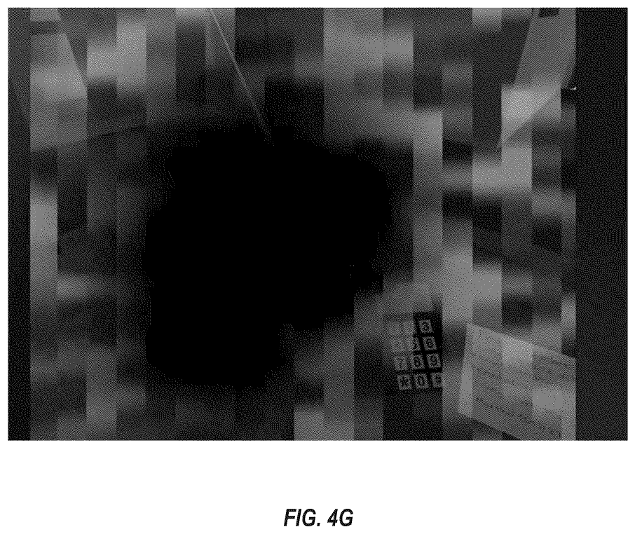

FIG. 4A illustrates an example virtual reality user interface for a selected training module, such as the medication management conversation module, according to one or more embodiments shown and described herein. FIG. 4B illustrates an example virtual reality interface for the selected training module according to one or more embodiments shown and described herein. FIG. 4C illustrates an example virtual reality interface for the selected training module according to one or more embodiments shown and described herein. FIG. 4D illustrates an example virtual reality interface for the selected training module according to one or more embodiments shown and described herein. FIG. 4E illustrates an example virtual reality interface for the selected training module according to one or more embodiments shown and described herein. FIG. 4F illustrates an example virtual reality interface for the selected training module according to one or more embodiments shown and described herein. FIG. 4G illustrates an example virtual reality interface for the selected training module according to one or more embodiments shown and described herein.

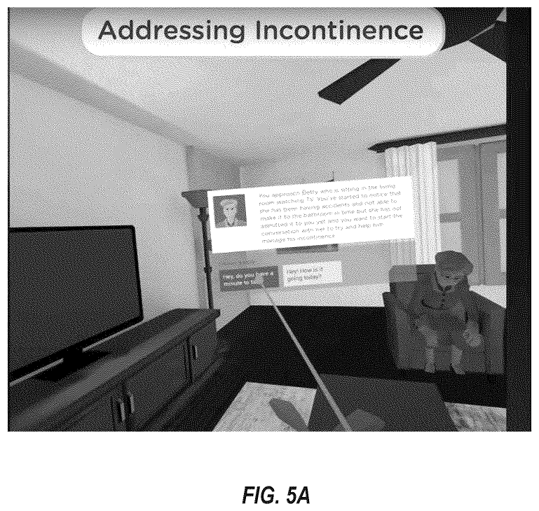

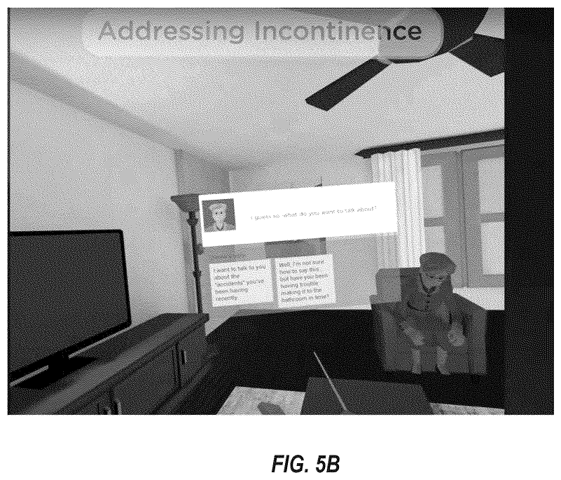

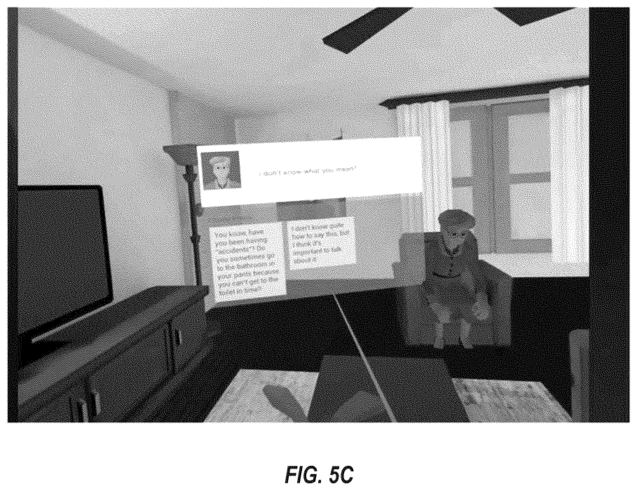

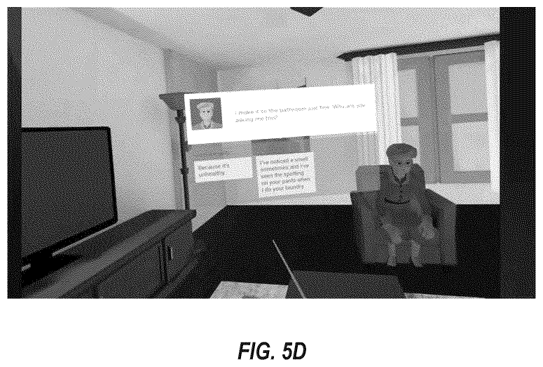

FIG. 5A illustrates an example virtual reality user interface for a selected training module, such as the incontinence conversation module, according to one or more embodiments shown and described herein. FIG. 5B illustrates an example virtual reality interface for the selected training module according to one or more embodiments shown and described herein. FIG. 5C illustrates an example virtual reality interface for the selected training module according to one or more embodiments shown and described herein. FIG. 5D illustrates an example virtual reality interface for the selected training module according to one or more embodiments shown and described herein.

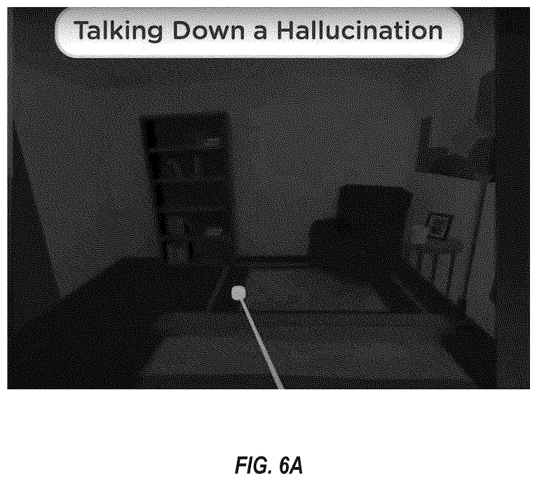

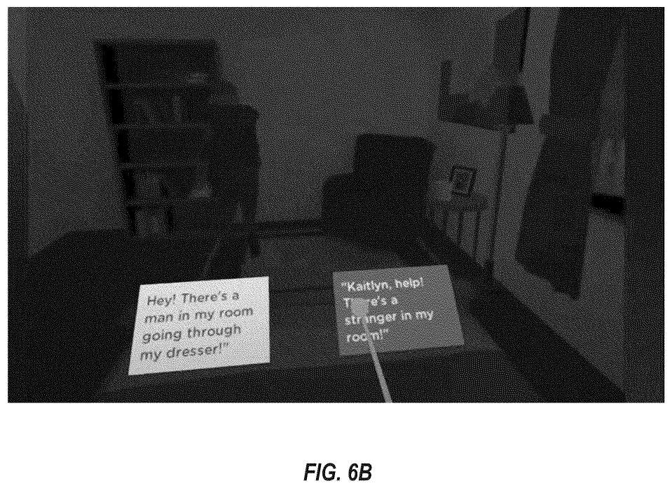

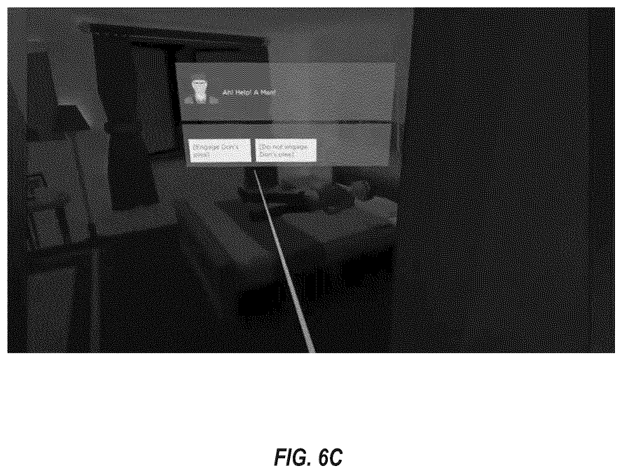

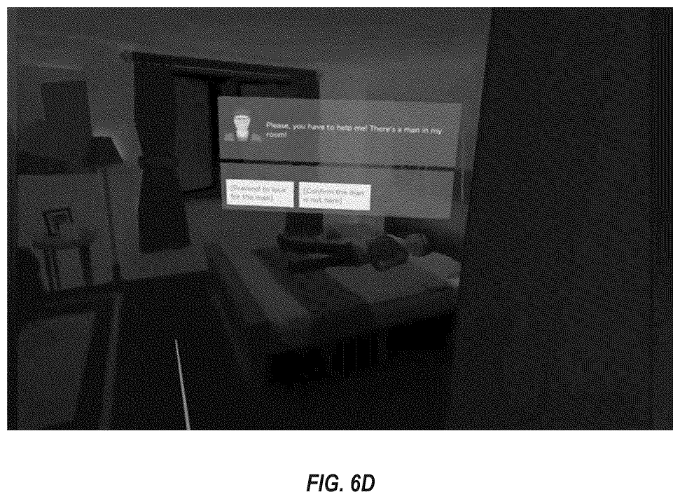

FIG. 6A illustrates an example virtual reality user interface for a selected training module, such as the hallucination conversation module, according to one or more embodiments shown and described herein. FIG. 6B illustrates an example virtual reality interface for the selected training module according to one or more embodiments shown and described herein. FIG. 6C illustrates an example virtual reality interface for the selected training module according to one or more embodiments shown and described herein. FIG. 6D illustrates an example virtual reality interface for the selected training module according to one or more embodiments shown and described herein.

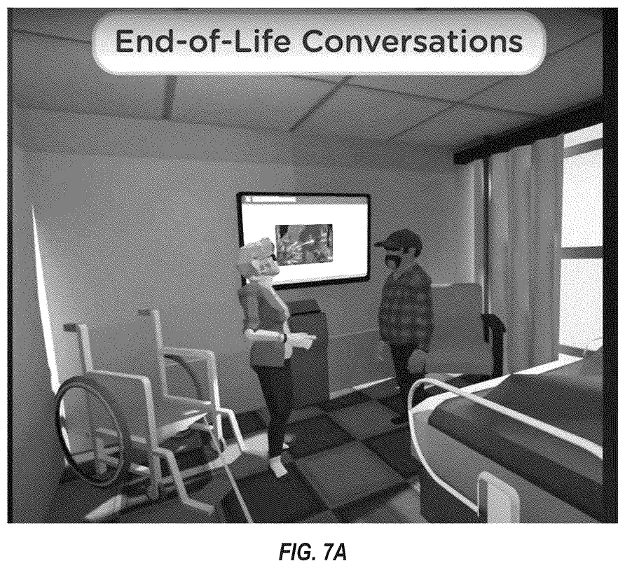

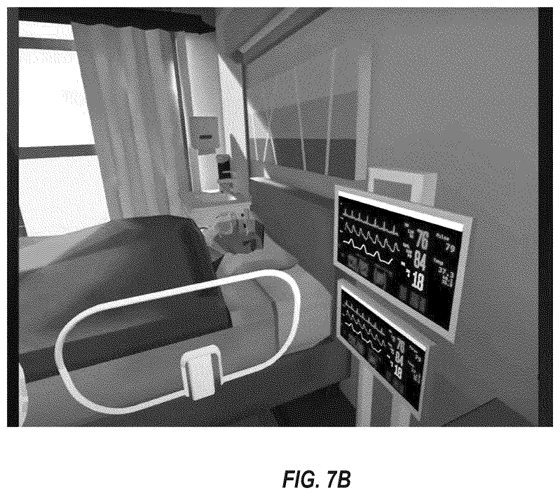

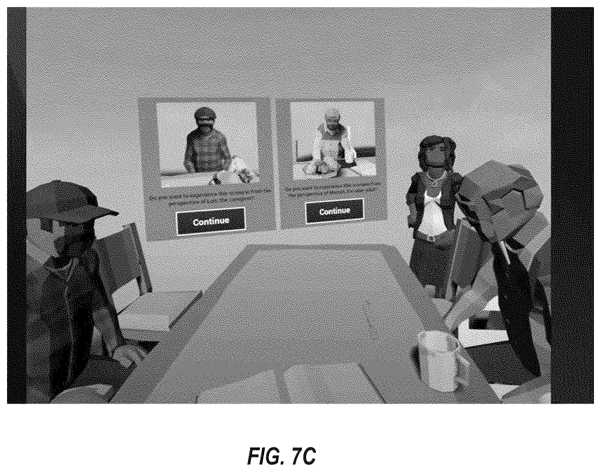

FIG. 7A illustrates an example virtual reality user interface for a selected training module, such as the end-of-life conversation module, according to one or more embodiments shown and described herein. FIG. 7B illustrates an example virtual reality interface for the selected training module according to one or more embodiments shown and described herein. FIG. 7C illustrates an example virtual reality interface for the selected training module according to one or more embodiments shown and described herein.

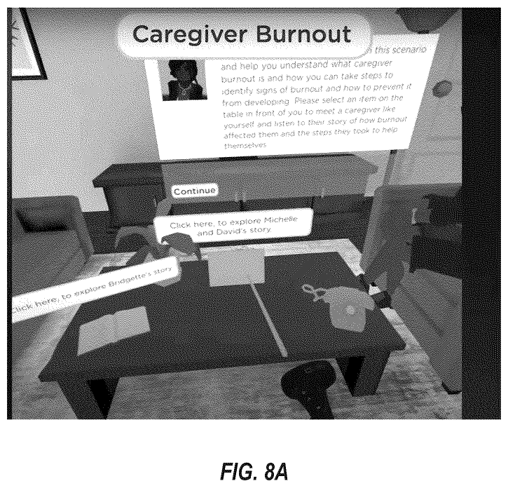

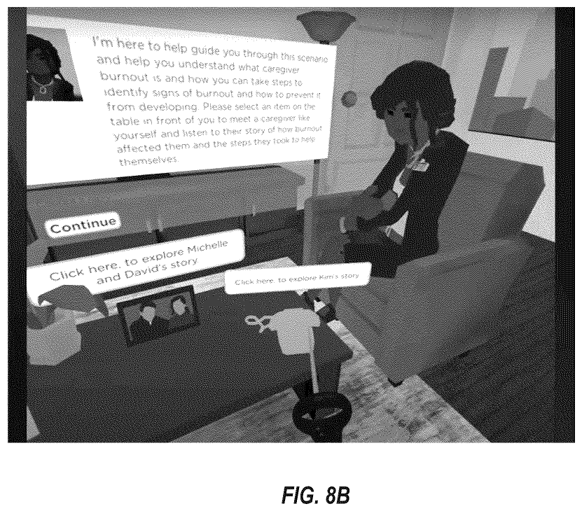

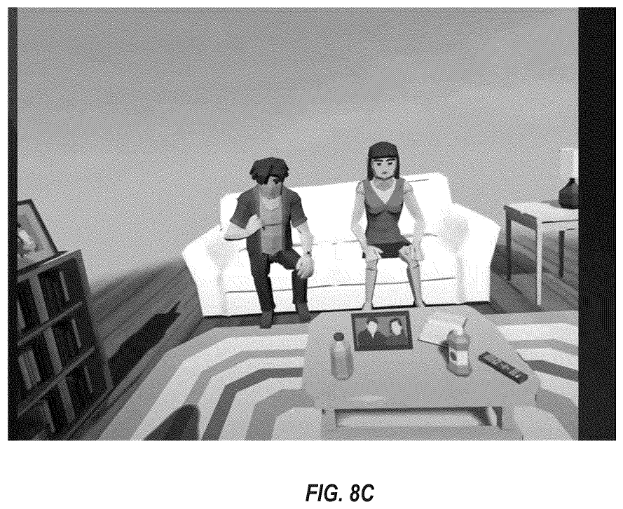

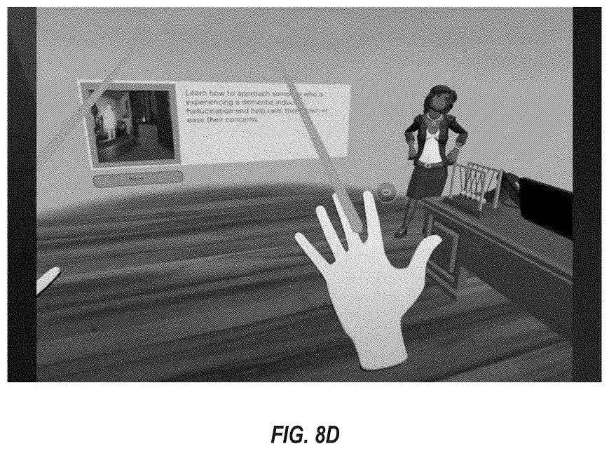

FIG. 8A illustrates an example virtual reality user interface for a selected training module, such as the caregiver burnout conversation module, according to one or more embodiments shown and described herein. FIG. 8B illustrates an example virtual reality interface for the selected training module according to one or more embodiments shown and described herein. FIG. 8C illustrates an example virtual reality interface for the selected training module according to one or more embodiments shown and described herein. FIG. 8D illustrates an example virtual reality interface for the selected training module according to one or more embodiments shown and described herein.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method comprising:
receiving input of selection of one of a plurality caregiver training modules using a virtual reality device;
displaying a first avatar in a virtual reality environment of the selected one caregiver training module;
viewing, from a first perspective of the first avatar, a plurality of health challenges associated with the first avatar;
interacting with the first avatar in the virtual reality environment via a plurality of prompts;
selecting one of a plurality of responses, in response to the plurality of prompts;
iteratively repeating the interaction with the first avatar up to a threshold number of the plurality of prompts; and
completing the selected one caregiver training module.

2. The method of claim 1, wherein the input comprises a manipulation of a controller, a voice command, a hand gesture, or any combination thereof.

3. The method of claim 1, wherein the virtual reality device comprises a virtual reality headset or a virtual reality eyewear.

4. The method of claim 1, wherein the plurality of caregiver training modules comprises a medication management conversation module, an incontinence conversation module, a hallucination conversation module, an end-of-life conversation module, and a caregiver burnout conversation module.

5. The method of claim 1, wherein the first avatar is customizable based on a plurality of first user parameters including a gender, a race, an ethnicity, an age, a language, a dialect, an accent, or any combination thereof.

6. The method of claim 1, wherein the plurality of prompts comprise one or more queries from the first avatar, and
wherein the plurality of responses comprise one or more responses in response to the one or more queries from the first avatar.

7. The method of claim 1, wherein the plurality of health challenges associated with the first avatar comprise a plurality of physical conditions associated with the first avatar, a plurality of mental conditions associated with the first avatar, or any combination thereof.

8. The method of claim 1, further comprising viewing a second perspective of a second avatar.

9. The method of claim 8, wherein the second avatar is customizable based on a plurality of second user parameters including a gender, an ethnicity, an age, or any combination thereof.

10. A system comprising:
one or more processors; and
one or more memories, wherein the one or more processors are configured to:
receive input of selection of one of a plurality caregiver training modules using a virtual reality device;
display a first avatar in a virtual reality environment of the selected one caregiver training module;
view, from a first perspective of the first avatar, a plurality of health challenges associated with the first avatar;
interact with the first avatar in the virtual reality environment via a plurality of prompts;
select one of a plurality of responses, in response to the plurality of prompts;
iteratively repeat the interaction with the first avatar up to a threshold number of the plurality of prompts; and
complete the selected one caregiver training module.

11. The system of claim 10, wherein the input comprises a manipulation of a controller, a voice command, a hand gesture, or any combination thereof.

12. The method of claim 10, wherein the virtual reality device comprises a virtual reality headset or a virtual reality eyewear.

13. The method of claim 10, wherein the plurality of caregiver training modules comprises a medication management conversation module, an incontinence conversation module, a hallucination conversation module, an end-of-life conversation module, and a caregiver burnout conversation module.

14. The method of claim 10, wherein the first avatar is customizable based on a plurality of first user parameters including a gender, a race, an ethnicity, an age, a language, a dialect, an accent, or any combination thereof.

15. The method of claim 10, wherein the plurality of prompts comprise one or more queries from the first avatar, and
wherein the plurality of responses comprise one or more responses in response to the one or more queries from the first avatar.

16. The method of claim 10, wherein the plurality of health challenges associated with the first avatar comprise a plurality of physical conditions associated with the first avatar, a plurality of mental conditions associated with the first avatar, or any combination thereof.

17. The method of claim 10, further comprising viewing a second perspective of a second avatar.

18. The method of claim 17, wherein the second avatar is customizable based on a plurality of second user parameters including a gender, a race, an ethnicity, an age, a language, a dialect, an accent, or any combination thereof.

19. The method of claim 10, further comprising authenticating a user via a facial recognition or a voice recognition.

20. A non-transitory computer-readable medium comprising instructions that, when executed by at least one processor, cause the at least one processor to perform operations comprising:
receiving input of selection of one of a plurality caregiver training modules using a virtual reality device;
displaying a first avatar in a virtual reality environment of the selected one caregiver training module;
viewing, from a first perspective of the first avatar, a plurality of health challenges associated with the first avatar;
interacting with the first avatar in the virtual reality environment via a plurality of prompts;
selecting one of a plurality of responses, in response to the plurality of prompts;
iteratively repeating the interaction with the first avatar up to a threshold number of the plurality of prompts; and
completing the selected one caregiver training module.
